(19) United States
(12) Patent Application Publication
(10) Pub. No.: US 2006/0252644 A1
(43) Pub. Date: Nov. 9, 2006

(54) Print creating method, image forming medium and printed product

(75) Inventor: Yukio Okamoto, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA BUSINESS TECHNOLOGIES, INC.

(21) Appl. No.: 11/338,811

(22) Filed: Jan. 25, 2006

(30) Foreign Application Priority Data
Apr. 28, 2005 (JP) JP2005-131447

(51) Int. Cl. B41M 5/24

(52) U.S. Cl. 503/201

(57) ABSTRACT

There is described a print creating method and a recording medium, which make it possible to create a print product having an excellent glossiness without increasing its cost. The method includes: forming a mirror image onto a first surface of the transparent substrate; peeling a light reflecting material having a tacking layer or an adhering layer, which is sticked on a second surface of said transparent substrate in advance, from said second surface; and laminating said tacking layer or said adhering layer of said light reflecting material, peeled off in said peeling step, onto said first surface of said transparent substrate bearing said mirror image formed in said forming step.

This application is based on Japanese Patent Application NO. 2005-131447 filed on Apr. 28, 2005 in Japanese Patent Office, the entire content of which is hereby incorporated by reference.

### BACKGROUND OF THE INVENTION

The present invention relates to a print creating method for creating a printed product having an image covered with a transparent substrate through which the image can be seen, an image forming medium and a printed product.

An image formed by an electrophotographic method is made of particulate toner, having irregularities on the image surface thereof and not showing uniform gloss, so that it has been difficult to form an image having uniform gloss like the silver photography, by the electrophotographic method.

Thus, studies have been conducted to make the image formed by the electrophotographic method have uniform gloss equivalent to the silver photography.

In order to form the image with excellent gloss, there is a method of devising a fixing step of applying heat fixing to a toner image. However, this method cannot perfectly solve a problem that gloss shown in a portion with the toner image and gloss shown in a portion with no toner image or less toner differ from each other. In addition, a problem that the portion with the toner image rises to form a relief-shape cannot be solved.

Proposed in Patent Document 1 is a method of transferring and fixing a mirror image of a document on a transparent film and adhering a light reflecting material on a toner image bearing surface of the transparent film.

The image formed by this method has a front surface on a surface opposite to the toner image bearing surface of the transparent film, in which the toner image is sandwiched between the transparent film and the light reflecting material. Thus, the front surface of the image is a mirror surface without bearing the toner image, so that the image with excellent and uniform gloss can be obtained.

[Patent Document 1]
Tokkaihei 7-56409 (Japanese Non-Examined Patent Publication)

The method disclosed in Patent Document 1 allows to form the image with excellent and uniform gloss and to prevent from forming the relief-shape image due to the raised toner image, thereby enabling to solve not only the problem specific to the image formed by the electrophotographic method, but also the problem in the image formed by an image forming method other than the electrophotographic method, such as an inkjet method.

In other words, the image is covered and protected with the transparent substrate, which makes it possible to create a printed product with high durability while preventing the peeling-off and fade-out of the image.

However, a specific apparatus is required to implement the method of Patent Document 1. In other words, the apparatus must be provided with a first accommodation section in which the transparent film is accommodated, a second accommodation section in which the light reflecting material is accommodated, and a laminating section for laminating the transparent film and the-light reflection material. In some cases, a coating section for coating adhesive or tack on the light reflecting material may be required.

The printed product such as a picture has a wide variety of demands ranging from a print of a document, a print of a drawing, to a copy of a manuscript such as a note, and the demand for the above described printed product with gloss is only a fraction of many of these printed product demands.

Thus, when the apparatus is provided with the above described several components that are used only for the printed product in which gloss is required and that not used for the other printed products, unnecessary cost increases, resulting in unwanted cost burdened by consumers of the printed product.

### SUMMARY OF THE INVENTION

To overcome the abovementioned drawbacks in conventional image-recording apparatus, it is an object of the present invention to provide a print creating method, a recording medium for forming an image (hereinafter, also referred to as an image forming medium) and a print product, which make it possible to create a print product having an excellent glossiness without increasing its cost.

Accordingly, to overcome the cited shortcomings, the abovementioned object of the present invention can be attained by a print creating method, a print product and a recording medium, described as follow.

(1) A print creating method for creating a printed product having an image covered with a transparent substrate, comprising the steps of: forming a mirror image onto a first surface of the transparent substrate; peeling a light reflecting material having a tacking layer or an adhering layer, which is sticked on a second surface of said transparent substrate in advance, from said second surface; and laminating said tacking layer or said adhering layer of said light reflecting material, peeled off in said peeling step, onto said first surface of said transparent substrate bearing said mirror image formed in said forming step.

(2) A recording medium on which an image is formed, comprising: a transparent substrate having a first surface on which the image is formable and a second surface being opposite side of the first surface; and a light reflecting material having a tacking layer or an adhering layer; wherein the transparent substrate and the light reflecting material contact each other by the tacking layer or the adhering layer on said second surface, and the transparent substrate is enable to be peeled off from the light reflecting material.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 shows an image forming medium according to Embodiment 1 of the present invention;

FIG. 2(a), FIG. 2(b), FIG. 2(c) and FIG. 2(d) show steps of a print creating method according to Embodiment 1 of the present invention;

FIG. 3 shows a light reflecting material;

FIG. 4(a) and FIG. 4(b) show a transparent substrate and an image formed on the transparent substrate;

FIG. 5(a) and FIG. 5(b) show examples of the peeling step and the laminating step;

FIG. 6 shows an image forming medium according to Embodiment 2 of the present invention;

FIG. 7(a), FIG. 7(b) and FIG. 7(c) show steps of a print creating method according to Embodiment 2 of the present invention;

FIG. 8(a), FIG. 8(b) and FIG. 8(c) show steps of a print creating method according to Embodiment 2 of the present invention;

FIG. 9(a), FIG. 9(b), FIG. 9(c) and FIG. 9(d) show steps of a print creating method according to Embodiment 3 of the present invention;

FIG. 10 shows a schematic block diagram of a color image forming apparatus, serving as a first exemplified apparatus for implementing an image forming process;

FIG. 11 shows a block diagram of an image processing section;

FIG. 12 shows an explanatory schematic diagram for explaining an operation of reading image data from an image memory; and

FIG. 13 shows a schematic block diagram of a color image forming apparatus, serving as a second exemplified apparatus for implementing an image forming process.

### DETAILED DESCRIPTION OF THE PREFERRED EMBODIMENT

Hereinafter the present invention will be described with reference to the embodiments, but the invention is not limited to these embodiments.

### (1) Embodiment 1 (1)-1 Image Forming Medium

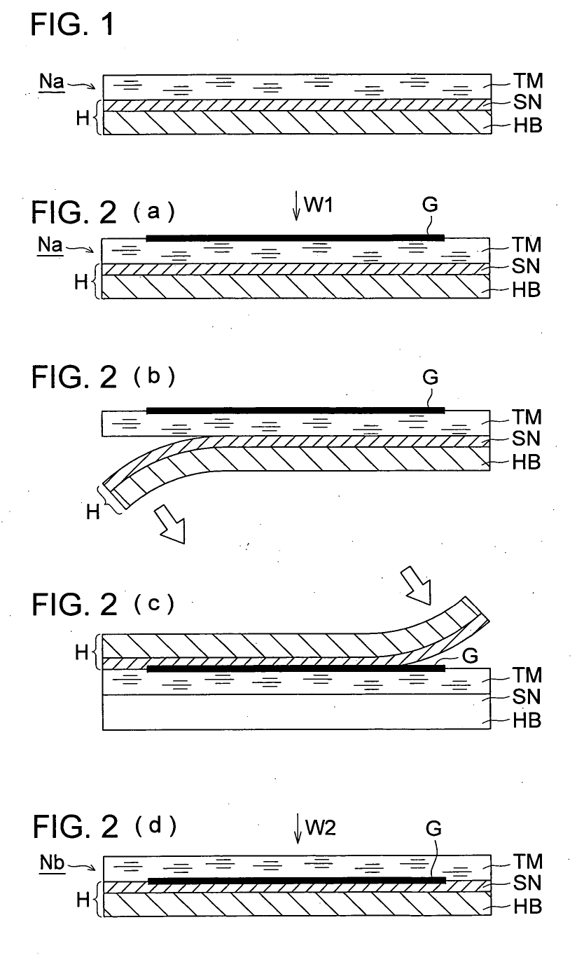

FIG. 1 shows an image forming medium according to Embodiment 1.

An image forming medium Na is made of a transparent substrate TM, a tacking (sticking) or adhering layer SN and a light reflecting substrate HB. The tacking or adhering layer SN and the light reflecting substrate. HB configure a light reflecting material H, in which the tacking or adhering layer SN is fixed on the light reflecting substrate HB.

Preferable for the transparent substrate TM is a PET (polyethylene terephthalate) film, preferably having a thickness of 50 to 500 μm.

When the thickness is less than 50 μm, the irregularities due to the toner image may appear on the front surface of the photographic print. When the thickness exceeds 500 μm, trouble may occur in the common processing within the electrophotographic image forming apparatus.

Further, in the case of using as an image forming medium for forming the image by the electrophotographic method, the transparent substrate TM preferably has a surface resistivity of 10⁷ ohm/square to 10¹² ohm/square. This makes it possible to implement good transfer to form a high quality image. When the resistivity is lower than 10⁷ ohm/square, good transfer is unlikely to be implemented due to a leakage of charge in the face method, sometimes causing the degradation of image quality. When higher than 10¹² ohm/square, unnecessary charge occurs, sometimes causing trouble in the delivery within the image forming apparatus or the degradation of image quality.

In order to properly adjust the resistivity of the transparent substrate as described above, the transparent substrate TM is preferably provided with an antistatic layer.

As described below, the transparent substrate TM and the light reflecting material H are peeled in the joint part of the transparent substrate TM and the tacking or adhering layer SN, the bonding force between the transparent substrate TM and the tacking or adhering layer SN is required to be smaller than the bonding force between the light reflecting substrate HB and the tacking or adhering layer SN. Thus, it is preferable to provide a separating layer that facilitates peeling off from the tacking or adhering layer SN, on a second surface which is the surface on the side contacting to the tacking or adhering layer SN of the transparent substrate TM configuring the image forming medium Na.

Further, the tacking or adhering layer SN of the light reflecting material H is laminated on a first surface which is the image bearing surface of the transparent substrate TM to form into a printed product. This printed product is used for such purposes as the appreciation, possession, and storage of the image, so that the bonding force between the first surface and the tacking or adhering layer SN is preferably large, and preferably larger than the bonding force between the second surface and the tacking or adhering layer SN.

The tacking or adhering layer SN is formed by a method of previously coating the light reflecting substrate HB with adhesive or tack, or other methods. As a result, differing from the case of the normal laminate, the tacking or adhering layer SN is in the state of being fixed on the side of the light reflecting substrate HB. Thereby, the image forming medium allows to easily form a high quality image on the transparent substrate without being influenced by the tacking or adhering layer, and enables to peel the light reflection material off from the back surface of the image forming surface and to laminate it on the image forming surface side. Further, in this state, the state in which the right reading image can be appreciated from the side from which the light reflecting material is peeled off is realized at the same time.

As the adhesive or tack, known ones can be used, including solvent acrylic adhesive and emulsion type adhesive.

The light reflection substrate HB is a reflective sheet of white, milky white, silver or other colors, and preferably is printing coated paper, synthetic paper (product name YUPO, etc.), resin coated paper, or resin film.

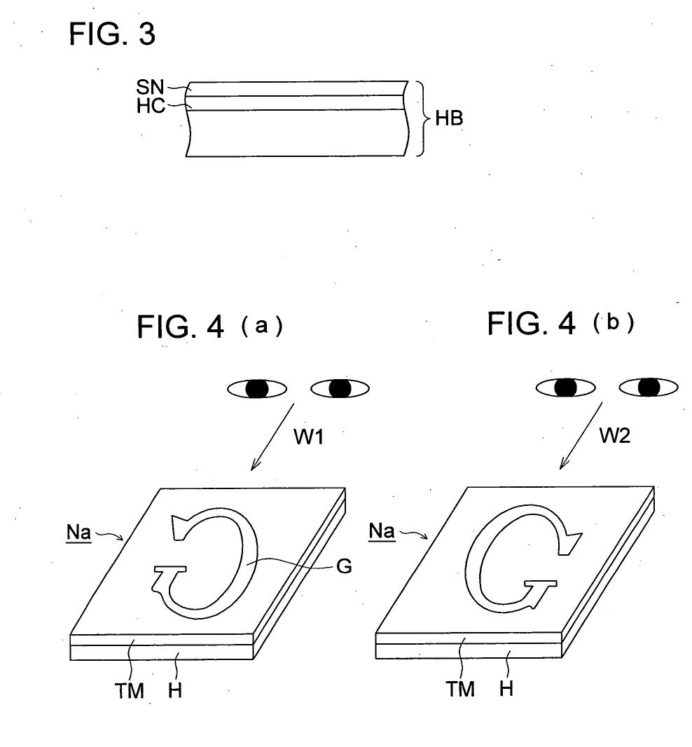

FIG. 3 shows the light reflecting material. In the case of using a coated paper as the light reflecting substrate, the light reflecting substrate HB has, as shown in FIG. 3, a coated layer HC on the side equivalent to the tacking or adhering layer SN of the light reflecting substrate HB. The adhering layer SN and the coated layer HC may also be formed into one layer using adhesive or tack as a binder of the coated layer HC.

With the coated paper containing polyolefins such as paraffin, polyethylene and polypropylene, these components are compatible with the toner wax to serve as the tacking or adhering layer. Thereby, it is possible to tightly bind the transparent substrate and the light reflecting material by using the coated paper containing the materials compatible with the wax and applying the heating and adhering step.

The image forming medium Na shown in FIG. 1 is formed by sticking the transparent substrate TM on the tacking or adhering layer SN of the light reflection material H.

FIG. 2(a), FIG. 2(b), FIG. 2(c) and FIG. 2(d) show the steps of a print creating method according to Embodiment 1 of the invention, wherein FIG. 2(a) shows an image forming step.

As shown in FIG. 2(a), an image G to be a mirror image is formed on the first surface of the transparent substrate TM. The image forming is implemented by the electrophotographic method described below, or also by any known image forming method such as the inkjet method. The image G is the mirror image upside-down or mirror-reversed, when viewed from direction W1 of the first surface (image bearing surface) of the transparent substrate TM. FIG. 4(a) shows the image G formed on the transparent substrate TM.

Next, as shown in FIG. 2(b), the light reflecting material H is peeled off from the transparent substrate TM.

Next, as shown in FIG. 2(c), the transparent-substrate TM is reversed front and back relative to the light reflection material H, and then the first surface bearing the image G of the transparent substrate TM is laminated on the adhering layer SN. FIG. 2(d) shows an image formed medium Nb that is formed by laminating as described above.

The right reading image can be observed by viewing the image formed medium Nb from direction W2 of the second surface opposite to the first surface bearing the image G of the transparent substrate TM. FIG. 4(b) shows the image G on the image formed medium Nb.

The print creating method according to the embodiment includes the following image forming step, peeling step and laminating step. The steps will be described below.

(1)-2 Image Forming Step

The image forming step is a step of forming a mirror image on the transparent substrate, in which known methods such as electrophotographic method, inkjet method and thermal transfer method can be used for the image forming.

The toner image formed on the transparent substrate is a mirror image of the original image mirror reversed or upside down.

The image forming step of forming the image by the electrophotographic method will be described below.

In the image forming by the electrophotographic method, an electrostatic latent image is formed on a photoreceptor by charging and exposing, and then an image is formed on the photoreceptor by developing. The image on the photoreceptor is transferred onto the transparent substrate of the image forming medium by applying direct transfer, or indirect transfer using an intermediate transfer body, and then fixed. In the exposure, an image exposure to the photoreceptor is implemented with a laser, an LED and the like, based on the image data. The image exposure is implemented so as to provide the mirror image G, viewed from the image bearing surface on the transparent substrate TM as shown in FIG. 4(a), by the image processing according to the number of transfers applied in direct transfer or indirect transfer.

In the development, a two-component developing agent containing toner and carrier as the main components is preferably used, in which polymer toner containing a wax for preventing offset in the fixing of the toner image is preferable for the toner.

(1)-3 Peeling Step and Laminating Step

The above described image forming step is implemented within the image forming apparatus, however, the step shown in FIG. 2(b) of peeling the light reflecting material made of the transparent substrate, the tacking or adhering layer and the light reflection material is implemented relative to the image forming medium ejected from the image forming apparatus. Similarly, the step shown in FIG. 2(c) of laminating the transparent substrate and the light reflecting material is implemented outside the image forming apparatus, after the transparent substrate is reversed front and back.

The above described peeling step and the laminating step are manually performed herein, but a tool for adjusting relative positions can be used in the laminating step.

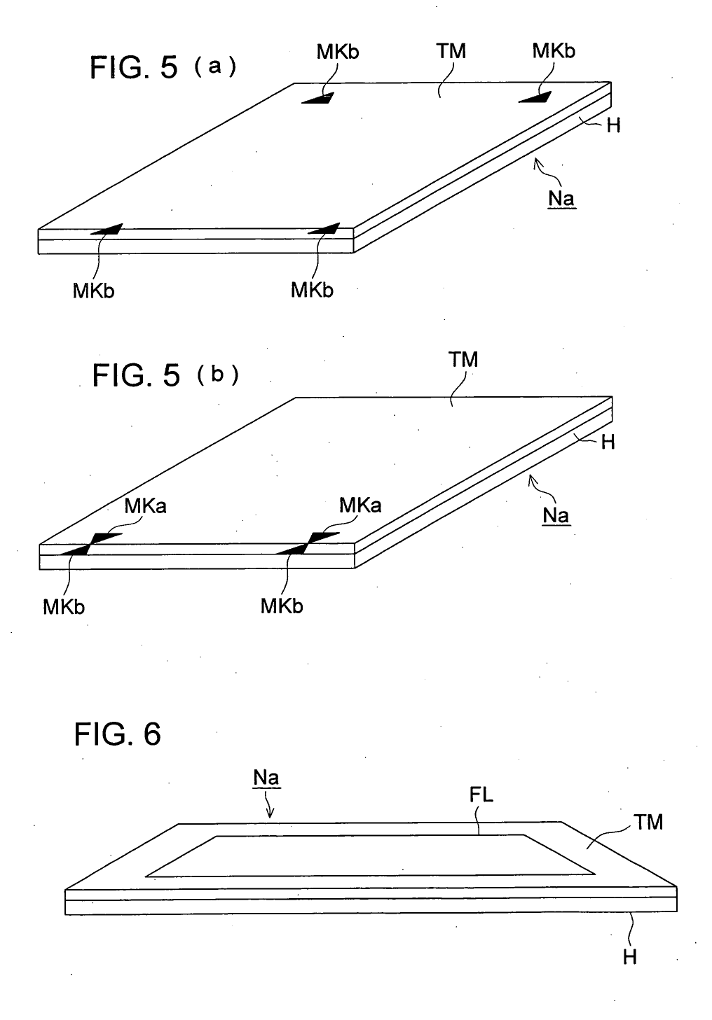

FIG. 5(a) and FIG. 5(b) show an example of the peeling step and the laminating step. As shown in FIG. 5(a), marks MKa for adjusting relative positions are provided at end portions of the transparent substrate TM configuring the image forming medium Na, and marks MKb for adjusting relative positions are provided at end portions of the light reflecting substrate HB on the side opposite to the former end portions. As shown in FIG. 5(b) in the laminating step, the marks MKa and MKb are adjusted to implement laminating, thereby the image formed medium Nb is formed.

The marks MKa, MKb are previously printed on the transparent substrate TM and the light reflecting material H, respectively.

### (2) Embodiment 2 (2)-1 Image Forming Medium

FIG. 6 shows the image forming medium according to Embodiment 2.

The image forming medium Na is made of the transparent substrate TM and the light reflecting material H, the light reflecting material H having the tacking or adhering layer, wherein the transparent substrate TM and the light reflecting material H are attached with the tacking or adhering layer.

The transparent substrate TM and the light reflecting material H are made of the same materials as in Embodiment 1, and the transparent substrate TM further has cut lines FL that form an image frame. The cut lines FL are so called perforated lines, and an image part TMG surrounded by the cut lines FL can be cut off from the other part of the transparent substrate TM.

In the example of the figure, the cut lines FL, although having a rectangular shape, may have a desired shape such as a circular, orbit, or heart shape.

(2)-2 Print Creating Method

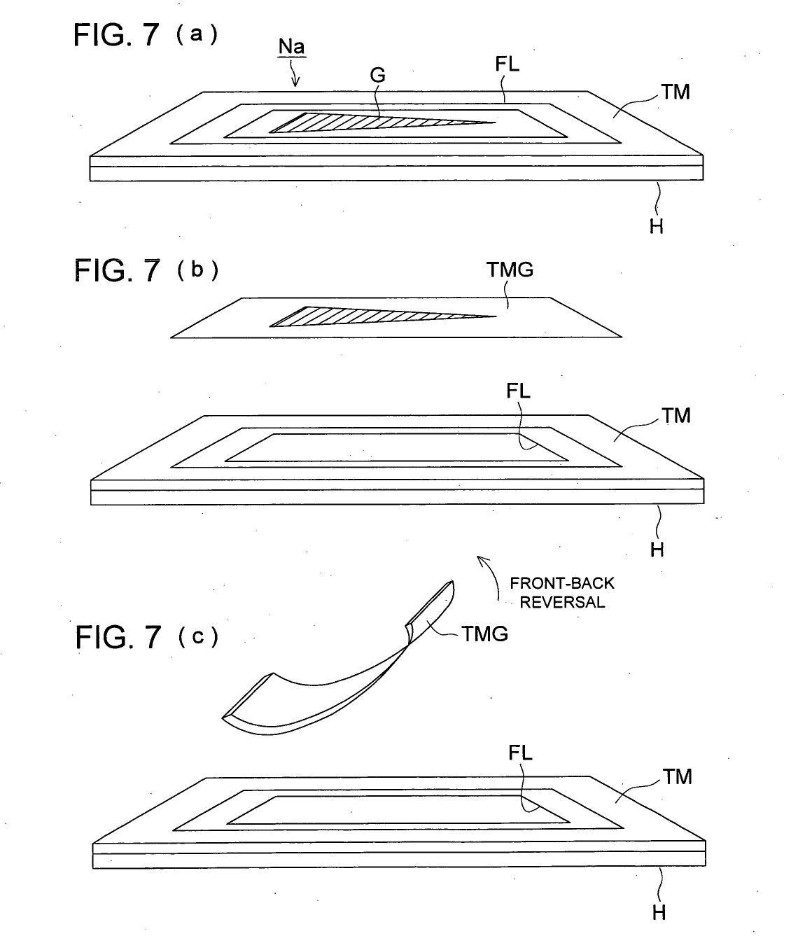

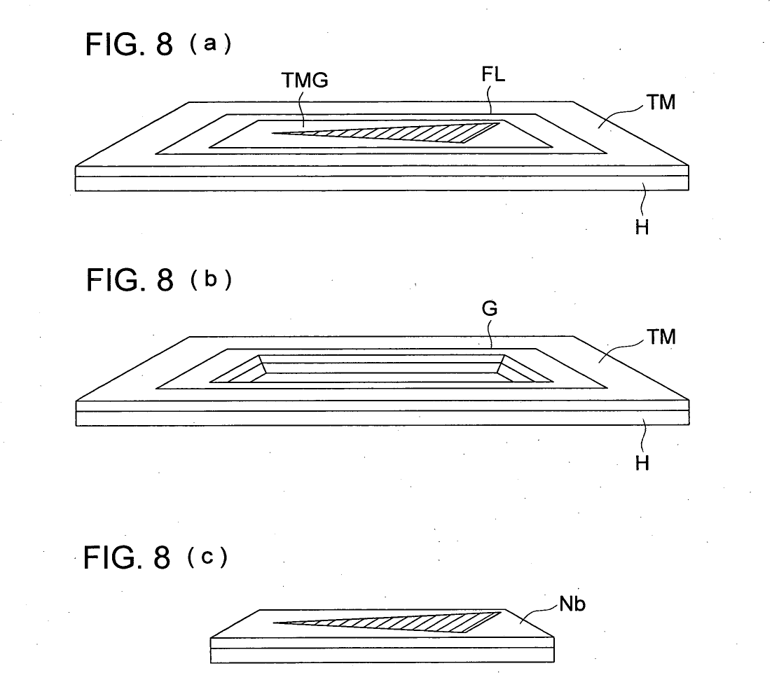

FIGS. 7 and 8 show the steps of the print creating method according to Embodiment 2 of the invention, wherein FIG. 7(a) shows the image forming step.

In FIG. 7(a), the image G is formed on the first surface of the transparent substrate TM of the image forming medium Na. The image G is formed in an area including the image part TMG of the transparent substrate, namely, the part surrounded by the cut lines FL, and slightly exceeding the relevant area.

By creating the image G in such a manner, an image without frame is formed. If the image G is largely beyond the image part TMG, the peripheral part of the image G is lost. The width of the peripheral part is desirably set to about at most 5 mm.

In FIG. 7(b), the image part TMG surrounded by the cut lines FL is peeled. The remaining part of the transparent substrate on the light reflecting material H is represented by (TM).

Next, in FIG. 7(c), the cut off image part TMG is reversed front and back so that the image bearing surface (first surface) of the image part TMG is-on the side of the light reflecting material H.

In FIG. 8(a), the reversed image part TMG is laminated on the light reflecting material H. In this laminating step, the cut lines FL can be used for adjusting relative positions, thereby the image part TMG can be laminated to the proper position.

Next, in FIG. 8(b), the image part TMG is cut along the cut lines FL to make the printed product Nb made of the transparent substrate TM and the light reflecting material H.

FIG. 8(c) shows the printed product Nb created through the above steps, and as shown in the figure, the printed product Nb has no frame.

In the case of forming the image by the electrophotographic method, when the image is formed over the medium area, toner scattering occurs, causing stains on the image and inside the apparatus. The problem that the toner scattering occurs when forming the frameless image by the electrophotographic method can be solved, as shown in FIGS. 7, 8, by forming the image G in the area including the image part TMG divided by the cut lings FL and cutting the image part along the cut lines FL.

### (3) Embodiment 3

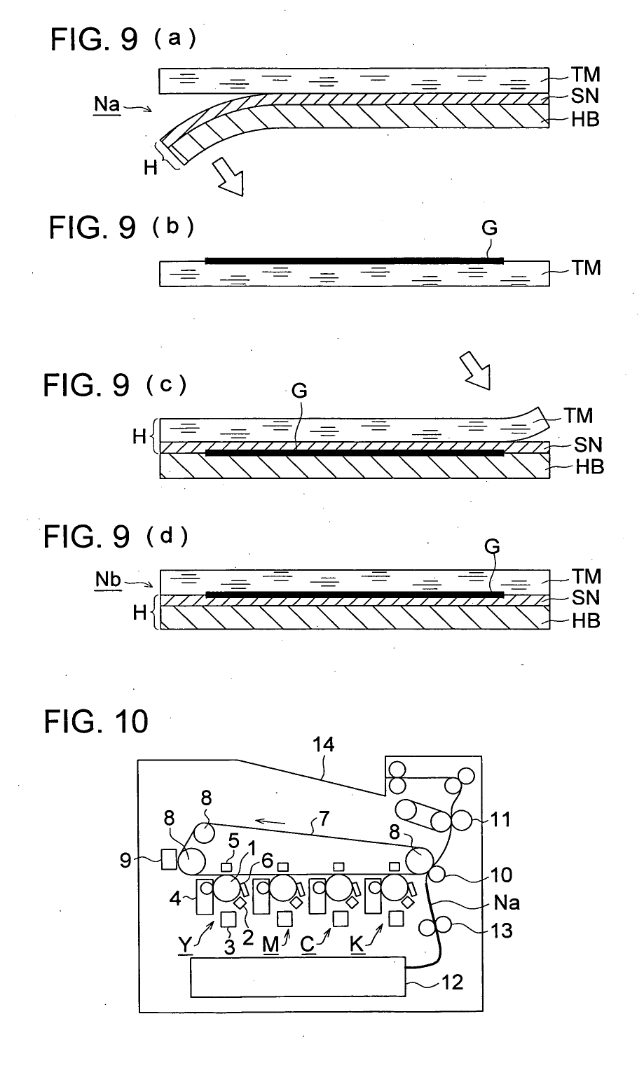

In this embodiment, the printed product Nb is created through the steps shown in FIGS. 9(a) through 9(d), using the image forming medium Na shown in FIG. 1 or FIG. 6.

First, as shown in FIG. 9(a), the transparent substrate TM is peeled off from the image forming medium Na made of the transparent substrate TM and the light reflecting material H. Incidentally, the light reflecting material H is made of the light reflecting substrate HB and the staking or adhering layer SN, as described above.

The image G is formed on the first surface of the peeled transparent substrate TM {FIG. 9(b)}. The image forming of FIG. 9(b) is implemented, for example, by an electrophotographic image forming apparatus shown in FIGS. 10, 13, which will be described below, but an image forming apparatus of another image forming method such as inkjet can also be used.

In this embodiment, since the image is formed on the single transparent substrate TM, there is an advantage that the delivery of the image forming material on which the image is to be formed and the processing for the image bearing material such as image fixing are easy.

Next, as shown in FIG. 9(c), the transparent substrate TM and the light reflecting material H are put together by laminating the first surface bearing the image G of the transparent substrate TM on the tacking or adhering layer SN of the light reflecting material H.

FIG. 9(d) shows the printed product Nb finished by the above steps. The image G is the right reading image viewed from the second surface side of the transparent substrate TM indicated by arrow W2.

(4) Image Forming Apparatus

FIG. 10 is a view showing a color image forming apparatus which is a first example of the apparatus for implementing the above described image forming step.

The color image forming apparatus has an image forming unit Y for forming a yellow toner image, an image forming unit M for forming a magenta toner image, an image forming unit C for forming a cyan toner image, and an image forming unit K for forming a black toner image.

The image forming units Y, M, C and K have the same configuration, thereby the reference numerals are assigned to the sections configuring the image forming section only for the yellow toner image, and other reference numerals are omitted. The description will be made below about the operation of the image forming unit Y, and the-operations of the image forming units M, C and K are the same as well.

A charging section 2, an exposure section 3, a developing section 4, a primary transfer section 5 and a clinging section 6 are provided around a drum-shape photoreceptor 1.

In the image forming, the photoreceptor 1 rotates in the clockwise direction, and the electrostatic latent image is formed on the photoreceptor 1 by the charge of the charging section 2 and the exposure of the exposure section 3. The formed electrostatic latent image is developed by the developing section 4 to form a toner image on the photoreceptor 1.

The toner image on the photoreceptor 1 is transferred onto an intermediate transfer body 7 by the primary transfer section 5.

On the intermediate transfer body 7 that is extended among a plurality of support rollers 8 and moves as indicated by the arrow, the yellow toner image formed in the image forming unit Y, the magenta toner image formed in the image forming unit M, the cyan toner image formed in the image forming unit C, and the black toner image formed in the image forming unit K are overlapped and transferred, thereby a multi color toner image is formed thereon.

The multi color toner image on the intermediate transfer body is transferred onto the image forming medium Na by a secondary transfer section 10.

The image forming medium Na on which the multi color toner image is formed is subjected to fixing processing through a fixing section 11.

The image forming medium Na accommodated in a cassette 12 is supplied sheet by sheet to the transfer section by paper feed rollers 13. The image forming medium Na is made of the materials shown in FIG. 1 or FIG. 6, namely, the transparent substrate TM and the light reflecting material H.

As the charging section 2, a scorotron charger having a discharge electrode and grid is preferably used.

As the exposure section 3, an exposure device for dot-exposing the photoreceptor 1 is preferably used, including a laser scanning exposure device, an LED array exposure device and the like.

As the developing section 4, a developing device for implementing the reversal development using the two-component developing agent containing toner and carrier as the main components is preferably used.

As the primary transfer section 5 and the secondary transfer section 10, transfer rollers with a transfer voltage applied or corotron chargers having a discharge electrode are preferably used.

As the cleaning section 6, a blade cleaning device using an elastic blade is preferably used.

As the fixing section 11, a heating device for heating the toner image by a roller or a belt is used.

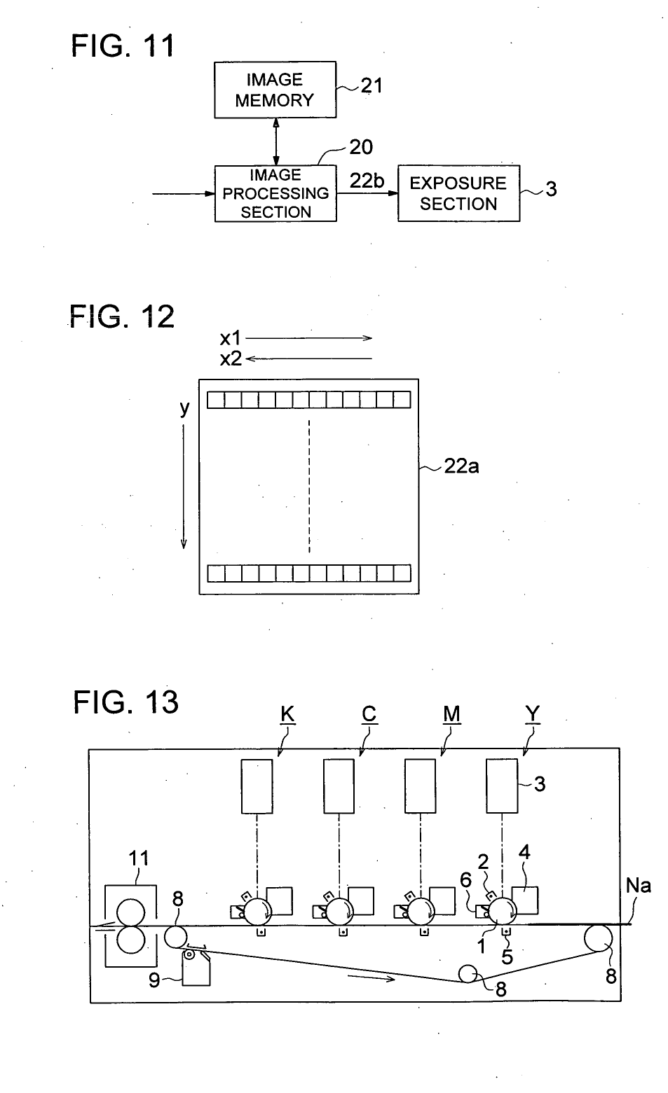

In the image forming units Y, M, C, K, the exposure device 3 exposes so that the mirror toner images are formed on the photoreceptor 1 respectively. FIG. 11 shows an image processing section for forming such mirror images.

An image processing section 20 that creates image data for driving the exposure device 3 reads the image data from an image memory 21 to create image data 22b. In the case of forming the mirror image, as shown in FIG. 12, the image processing section 20 reads image data 22a stored in the image memory 21 in the main scanning direction, in the order x2 reverse to the order x1 in writing, and then reads the image data 22a in the sub scanning direction in the order y in writing, thereby to create the image data 22b.

The toner image formed-on the photoreceptor 1 is transformed into the right reading image on the intermediate transfer body 7, and the image is transferred onto the image forming medium Na to provide the mirror image.

FIG. 13 is a view showing a color image forming apparatus which is a second example of the apparatus for implementing the above described image forming step.

The image forming section includes an image forming unit Y for forming a yellow toner image, an image forming unit M for forming a magenta toner image, an image forming unit C for forming a cyan toner image, and an image forming unit K for forming a black toner image.

The image forming units Y, M, C and K have the common configuration, thereby the reference numerals are assigned to the sections configuring the image forming section only for the yellow toner image, and other reference numerals are omitted. The operation of the image forming unit Y will be described below, and the operations of the image forming units M,.C, and K are the same as well.

The charging section 2, the exposure section 3, the developing section 4, transfer section 5 and the cleaning section 6 are provided around the drum-like photoreceptor 1.

In the image forming, the photoreceptor 1 rotates in the clockwise direction, and the electrostatic latent image is formed on the photoreceptor 1 by the charge of the charging section 2 and the exposure of the exposure-section 3. The formed electrostatic latent image is developed by the developing section 4 to form a toner image on the photoreceptor 1.

The toner image on the photoreceptor 1 is transferred onto the image forming medium Na by the transfer section 5.

On the image forming medium Na, a yellow toner image formed in the image forming unit Y, a magenta toner image formed in the image forming unit M, a cyan toner image formed in the image forming unit C, and a black toner image formed in the image forming unit K are overlapped and transferred, thereby a multi color toner image is formed thereon.

The image forming medium Na on which the multi color image is formed is subjected to fixing processing through the fixing section 11.

In the example, the right reading toner image of the original image is formed on the photoreceptor 1 by the exposure section 3, and the mirror toner image is formed on the image forming medium Na.

Such a right reading image is formed, when the image processing section 20 in FIG. 11 reads the mage data 22a from the image memory 21, by driving the exposure section 3 by the image data 22b that is read in the same order x1 as the order in writing.

While the preferred embodiments of the present invention have been described using specific term, such description is for illustrative purpose only, and it is to be understood that changes and variations may be made without departing from the spirit and scope of the appended claims.

What is claimed is:

1. A print creating method for creating a printed product having an image covered with a transparent substrate, comprising the steps of:
forming a mirror image onto a first surface of said transparent substrate;
peeling a light reflecting material having a tacking layer or an adhering layer, which is sticked on a second surface of said transparent substrate in advance, from said second surface; and
laminating said tacking layer or said adhering layer of said light reflecting material, peeled off in said peeling step, onto-said first surface of said transparent substrate bearing said mirror image formed in said forming step.

2. The print creating method of claim 1,
wherein said peeling step is implemented after said forming step is completed.

3. The print creating method of claim 1,
wherein said peeling step is completed before said forming step.

4. The print creating method of claim 1,
wherein position adjusting marks, for adjusting relative positions of said transparent substrate and said light reflecting material to each other in said laminating step, are formed on both said transparent substrate and said light reflecting material.

5. The print creating method of claim 1,
wherein said transparent substrate includes an image area comparted by cut lines; and
wherein, in said peeling step, only a portion of said light reflecting material laminated within said image area is peeled off from said second surface of said transparent substrate along said cut lines, and, in said laminating step, said portion of said light reflecting material is laminated onto said-image area of said first surface of said transparent substrate while adjusting relative positions of them along said cut lines.

6. The print creating method of claim 5, further comprising the step of:
cutting said transparent substrate laminated with said light reflecting material along said cut lines after said laminating step.

7. The print creating method of claim 1, further comprising the step of:
cutting said transparent substrate laminated with said light reflecting material after said laminating step.

8. The print creating method of claim 1,
wherein said mirror image is a multi color image that is formed by overlapping a plurality of unicolor images.

9. The print creating method of claim 1,
wherein said transparent substrate is made of a resin film.

10. The recording medium of claim 1,
wherein an adhesive force between said first surface of said transparent substrate and said tacking layer or said adhering layer is larger than that between said second surface of said transparent substrate and said tacking layer or said adhering layer.

11. A printed product having an image covered with a transparent substrate, said printed product is made by said method of claim 1.

12. A recording medium on which an image is formed, comprising:
a transparent substrate having a first surface on which said image is formable and a second surface being opposite side of said first surface; and
a light reflecting material having a tacking layer or an adhering layer;
wherein said transparent substrate and said light reflecting material contact each other by said tacking layer or said adhering layer on said second surface, and said transparent substrate is enable to be peeled off from said light reflecting material.

13. The recording medium of claim 12,
wherein said transparent substrate further has an antistatic layer.

14. The recording medium of claim 12,
wherein a surface resistivity of at least said first surface of said transparent substrate is in a range of 10⁷-10¹² Ω/□.

15. The recording medium of claim 12,
wherein an adhesive force between said first surface of said transparent substrate and said tacking layer or said adhering layer is larger than that between said second surface of said transparent substrate and said tacking layer or said adhering layer.

16. The recording medium of claim 12,
wherein said transparent substrate is made of a resin film.

17. The recording medium of claim 12,
wherein said light reflecting material is made of a paper or a resin film, having a white color, a translucent white color or a silver color.

18. The recording medium of claim 12,
wherein said recording medium is shaped in a cut sheet.

19. The recording medium of claim 12,
wherein position adjusting marks, for adjusting relative positions of said transparent substrate and said light reflecting material to each other, are respectively formed on said transparent substrate and said light reflecting material.

20. The recording medium of claim 12,
wherein said transparent substrate is provided with cut lines for dividing an image area.
